(19) United States
(12) Patent Application Publication
(10) Pub. No.: US 2020/0147502 A1
(43) Pub. Date: May 14, 2020

(54) Game Console Stand and Bracket

(71) Applicant: Maoquan Deng, Irvine, CA (US)

(72) Inventor: Maoquan Deng, Irvine, CA (US)

(21) Appl. No.: 16/530,942

(22) Filed: Aug. 2, 2019

Related U.S. Application Data
(60) Provisional application No. 62/714,074, filed on Aug. 2, 2018.

(51) Int. Cl. A63F 13/98

(52) U.S. Cl. CPC A63F 13/98

(57) ABSTRACT

A game console stand or bracket includes a supporting plate and a base. One end of the supporting plate is in movable connection with the base by use of a protruding connecting piece coupled to the supporting plate and is received in a corresponding slot on the base. When the game console stand is in an open configuration, the supporting plate flips outward and reclines on the base so that a game console can be supported by the supporting plate and coupled to a connector member, such as a USB connector. When the game console stand is not used, the console is removed from the supporting plate, which is then flipped inwards to a closed position to conceal and protect the connector member. The game console stand has a flat shape and is convenient to carry when in the closed configuration.

### CROSS-REFERENCE TO RELATED APPLICATION

This application claims priority to U.S. provisional patent application 62/714,074, filed on Aug. 2, 2018, the entire content of which is incorporated by reference.

### TECHNICAL FIELD

This subject matter is generally related to game console stands and brackets.

### BACKGROUND

A game console stand can support a game console in a position that is comfortable for use by the user. In some examples, a game console stand has clips that clip onto the front and back of the game console to secure the game console while in use. Such a configuration may reduce the heat dissipation of the game console, and the clips may scratch the display screen of the game console. The game console stand may have a large size that is inconvenient for the user to carry. Signal and power lines connected to the game console may protrude from the game console, resulting in a messy and unappealing arrangement. The signal and power lines may be bent at angles that result in damage to the lines after long term use. The game console stand may be inconvenient to store, e.g., in a shallow desk drawer.

### SUMMARY

This disclosure describes a game console stand or dock or bracket that supports a game console at a position that is convenient for the user to use the game console. The game console can be, e.g., a game controller. The game console stand or dock or bracket can have a number of configurations. In a first configuration, the game console stand or dock or bracket supports the game console at a position that is convenient for the user, e.g., the game console can be tilted at an angle that makes it easy for the user to view the display screen of the game console and operate the buttons or joysticks on the game console. In a second configuration, the game console is removed from the game console stand or dock or bracket, and the game console stand or dock or bracket can be adjusted to have a small size that is convenient for the user to carry or store. The game console stand or dock or bracket has a connecting unit for connecting to an interface of the game console. When the game console is removed from the game console stand or dock or bracket, the connecting unit is concealed and protected by the game console stand or dock or bracket. In some examples, the game console stand or dock or bracket can also enhance heat dissipation of the game console while the game console is in use. In some examples, the body of the game console stand or dock or bracket includes a rechargeable battery, and the game console stand or dock or bracket can be used as a power bank.

In a general aspect, an apparatus includes a game console stand. The game console stand includes: a base having a top surface and a bottom surface; and a supporting member rotatably coupled to the base, in which the supporting member comprises a supporting plate and a connecting unit, the supporting plate has a front surface and a back surface, the supporting plate is configured to provide support for a game console, the connecting unit is rotatably coupled to the base, and the connecting unit is configured to connect with an interface of the game console. The game console stand is configured to have an open configuration and a closed configuration, in which when the game console stand is in the closed configuration, the front surface of the supporting plate faces the bottom surface of the base, and the top surface of the base and the back surface of the supporting plate form the outer surfaces of the game console stand in the closed configuration. When the game console stand changes from the closed configuration to the open configuration, the supporting plate is rotated outwards such that the front surface of the supporting plate faces away from the base and is configured to provide support for the game console.

In another general aspect, an apparatus includes a game console stand. The game console stand includes a base; a supporting member rotatably coupled to the base, the supporting member configured to support a game console when the game console stand is used to support the game console; and a connector that is received within a housing member of the supporting member when the game console is not placed on the supporting member, wherein the connector protrudes from the housing member when the game console is placed on the supporting member, and the connector is coupled to an interface of the game console.

### BRIEF DESCRIPTION OF THE DRAWINGS

FIG. 1 is a perspective view of a game console stand or dock or bracket that includes a base and a supporting member.

FIG. 2 is an exploded view of the game console stand or dock or bracket.

FIG. 3 is a cross-sectional view of the game console stand or dock or bracket.

FIG. 4 is another perspective view of the game console stand or dock or bracket.

FIG. 5 is a cross-sectional view of the supporting member when a game console is not placed on the game console stand or dock or bracket.

FIG. 6 is a cross-sectional view of the supporting plate when the game console is not placed on the bracket.

FIG. 7 is a schematic diagram of the game console stand or bracket when used with a game console.

FIGS. 8A to 8H are front perspective, rear perspective, top, front, rear, left, right, and bottom views, respectively, of an example game console stand or dock or bracket in an open configuration.

FIGS. 9A to 9H are front perspective, rear perspective, top, front, rear, left, right, and bottom views, respectively, of the example game console stand, dock, or bracket in a closed configuration.

FIG. 10 is a bottom view of an example gaming console.

Like reference symbols in the various drawings indicate like elements.

### DETAILED DESCRIPTION

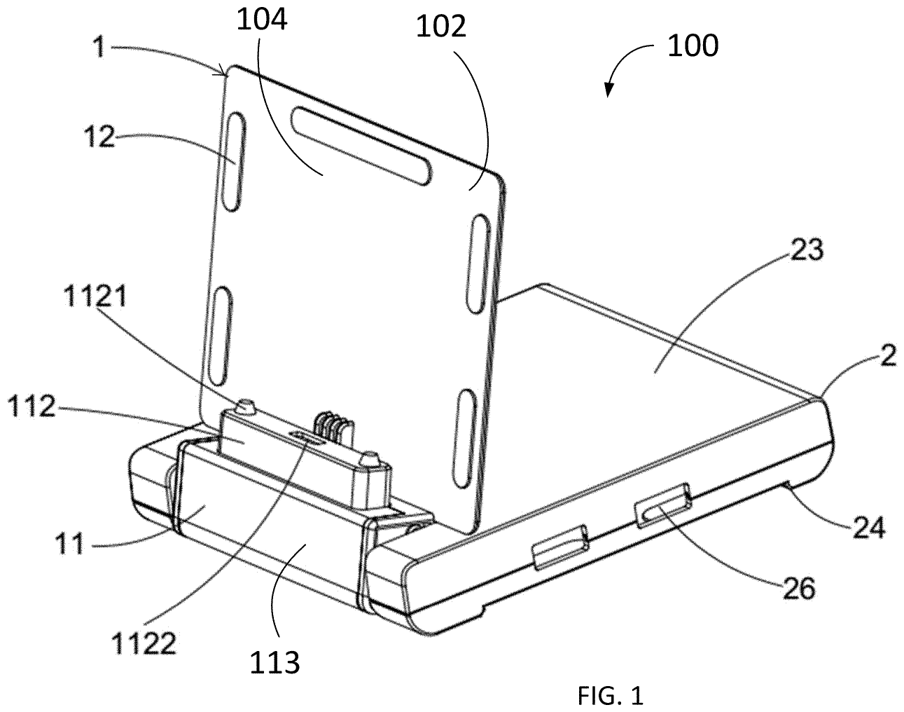

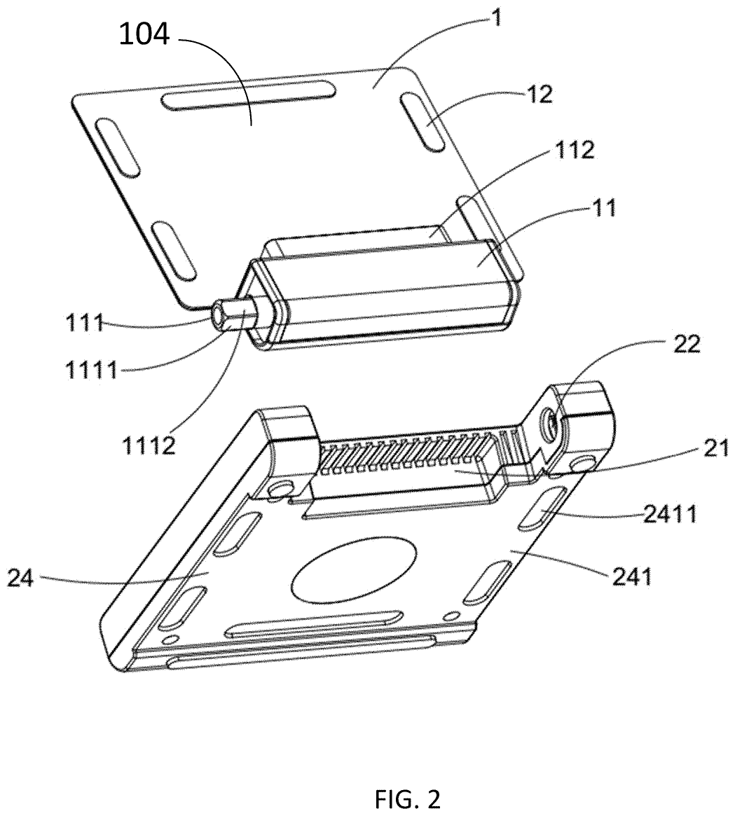

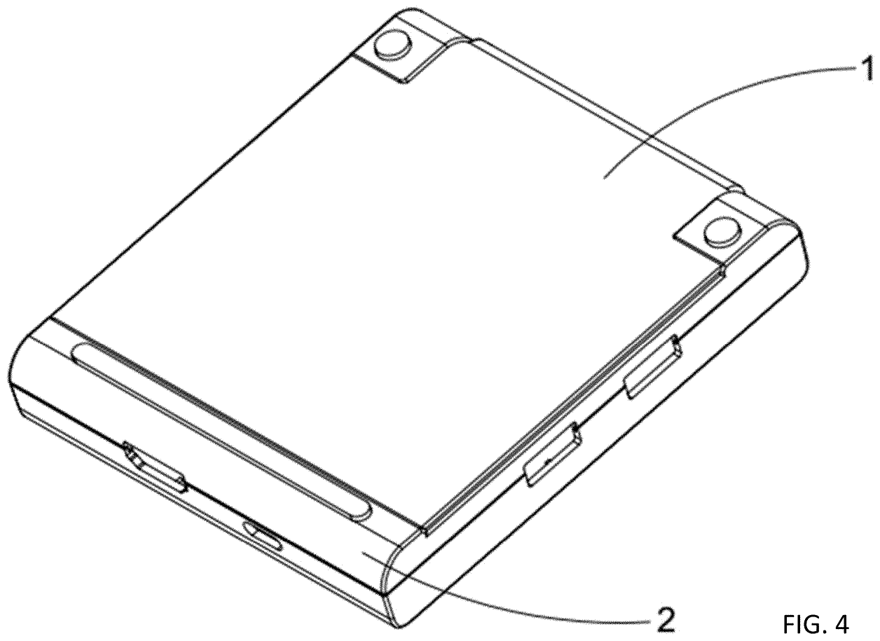

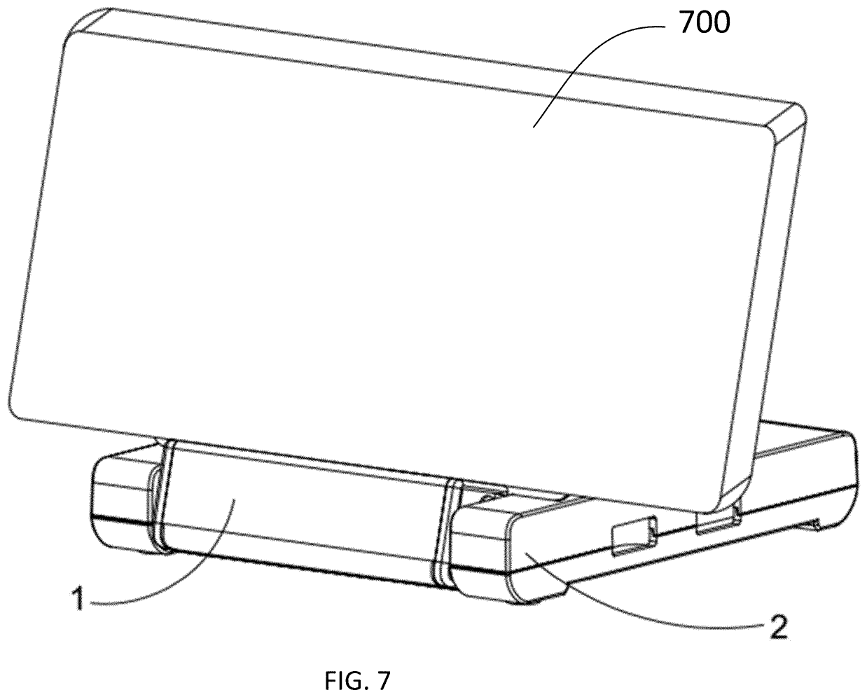

Referring to FIGS. 1 to 7, in some implementations, a game console (or controller) stand or dock or bracket 100 includes a supporting member 1 and a base 2. The supporting member 1 can include a supporting plate 102 and a connecting unit 11. The supporting plate 102 is configured to support a game console 700 (FIG. 7), and the connecting unit 11 is configured to connect to an interface (e.g., a universal serial bus (USB) port) of the game console. One end (e.g., the lower end) of the supporting member 1 is in movable connection with the base 2. For example, the supporting member 1 can be rotatably or pivotly coupled to the base 2. The base 2 has a slot 21 (FIG. 2) that corresponds to the connecting unit 11.

In the following, a game console stand is described, but the same design principle can also be applied to a game console dock or bracket. When the user uses the game console stand 100 to support the game console 700, the user flips the supporting member 1 outward and cause the supporting plate 102 to recline at an angle on the base 2. The game console 700 is placed on the connecting unit 11 and stably supported by the supporting plate 102. When the game console 700 is removed from the game console stand 100, the supporting member 1 can be moved to a closed configuration by flipping the supporting member 1 inwards, causing the supporting member 1 to be received in the base 2 or in a recess in the base 2. In the closed configuration of the supporting member 1, the connecting member 11 is received in the slot 21 of the base 2. A feature of the game console stand 100 is that it has a rotatable supporting member 1 that includes the supporting plate 102 that can function as a cover to conceal and protect the connecting unit 11 when the game console stand 100 is not in use and in the closed configuration. Further, when the supporting member 1 is in the closed configuration, the game console stand 100 has an overall flat shape and is portable and convenient to store in a shallow container, such as a desk drawer. The supporting plate 102 increases the game console's heat dissipation area and effectively solves the overheating problem.

In some implementations, the base 2 includes two connecting slots 22. The connecting unit 11 includes two connecting rods 111 at two ends of the connecting unit 11, in which the two connecting rods 111 are configured to be respectively coupled to the two connecting slots 22 of the base 2. For example, each of the connecting rods 111 is inserted into the corresponding connecting slot 22, thereby movably coupling the supporting member 1 to the base 2. When the supporting member 102 moves from the closed configuration to the open configuration, the supporting member 102 rotates about an axis that passes through the two connecting rods 111.

When the supporting member 1 is flipped from the closed configuration to the open configuration, the connecting rods 111 of supporting member 1 rotate within the connecting slot 22 to a certain angle so that the supporting plate 102 reclines at an angle and is stably supported by the base 2. In the process of flipping open the supporting member 1, the surfaces of the connecting rods 111 slide against the surfaces of the connecting slots 22, the frictional force between the surfaces of the connecting rods 111 and the connecting slots 22 provides a stabilizing force for the supporting member 1.

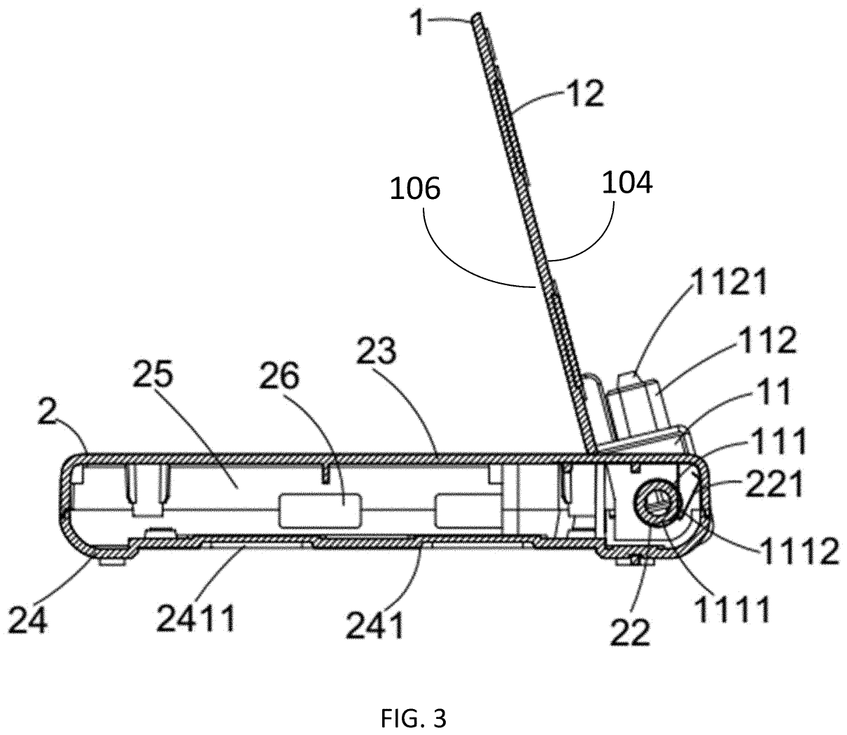

In some implementations, one or more spring members 221 (e.g., spring clips) are fitted in each of the connecting slots 22, and the one or more spring members 221 (FIG. 3) provide a spring force that is biased against the connecting rod 111. The connecting rod 111 is designed to have a first contact face 1111 and a second contact face 1112, in which each of the first contact face 1111 and the second contact face 1112 is set at a predetermined angle relative to the body of the connecting unit 11. The remaining surface of the connecting rod 111 is curved. In the natural state (i.e., without external force), the spring member 221 has a shape that corresponds to the shape of the first and/or second contact faces 1111, 1112. An external force can be applied to cause the spring member 221 to become curved. When the game console stand 100 is not in use and in the closed configuration, the first contact face 1111 faces the spring member 221 and allows the spring member 221 to spread to its natural state that corresponds to the shape of the first contact face 1111. In the process of adjusting the supporting member 1 from the closed configuration to the open configuration, the connecting rod 111 rotates with the supporting plate member 1, in which the first contact face 1111 moves away from the spring member 221. The curved surface of the connecting rod 111 presses against the spring member 221 to cause the spring member 221 to become curved. The spring member 221 remains in the curved configuration until the connecting rod 111 rotates to another position such that the second contact face 1112 faces the spring member 221. In some examples, the supporting member 1 is configured such that when the second contact face 1112 faces the spring member 221, the supporting plate 1 is in the open configuration and is securely supported by the base 2.

The spring member 221 provides a stabilizing force to the connecting rod 111 and helps stabilize the supporting member 1. When the game console stand 100 is not in use and in the closed configuration, the supporting member 100 is received in the base 2, or a recess in the base 2, and the first contact face 1111 faces the spring member 221.

In some implementations, the first contact face 1111 is flat so that the spring member 221 spreads flat when facing the first contact face 1111. When the supporting member 1 is rotated, the first contact face 1111 will move relative to the spring member 221 and the first contact face 1111 will be separated from the spring member 221. The spring member 221 is compressed by the curved surface of the connecting rod 111 to generate a certain amount of spring force. When the supporting member 1 is in the closed configuration, if a small force is applied to the supporting plate 102, the spring force generated by the spring member 221 will counteract the small force applied to the supporting plate 102 and prevent the supporting member 1 from rotating away from the closed configuration. The user needs to apply a force that is greater than a preset level in order to change the supporting member 1 from the closed configuration to the open configuration. The design of the spring member 221 effectively prevents the supporting plate 102 from being opened by an unidentified external force and effectively protects the supporting member 1 and the connecting unit 11 of the game console stand 100 from damage or scratches caused by external forces. For example, the user may carry the game console stand 100 in a backpack along with other objects, and the configuration of the first contact face 1111 and the spring member 221 prevents the supporting member 1 from being opened due to bumping from other objects in the backpack.

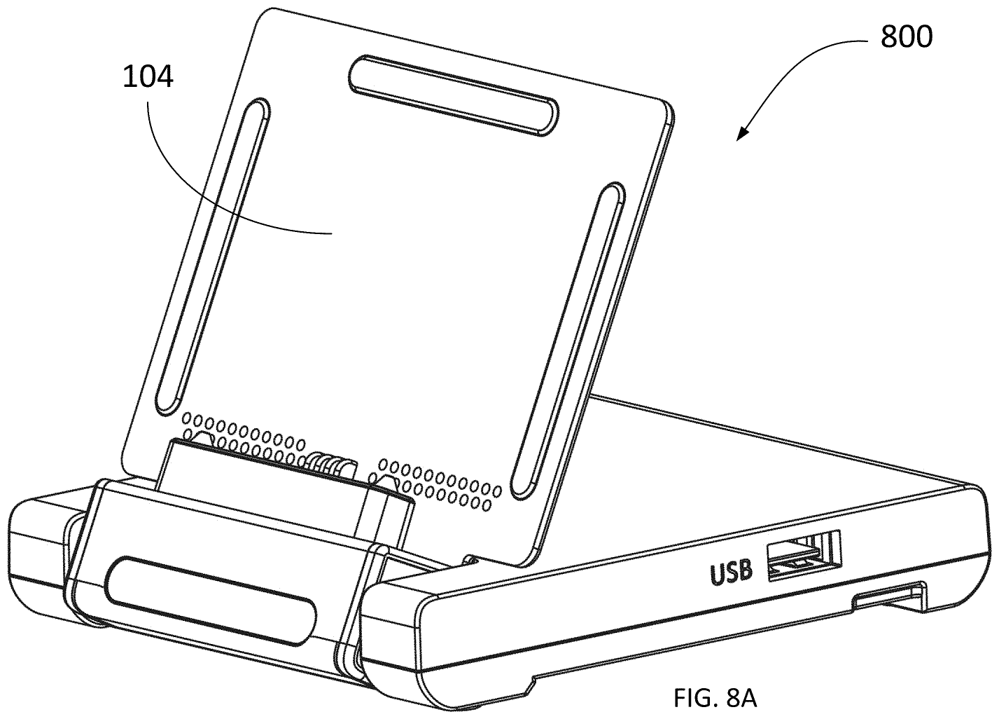

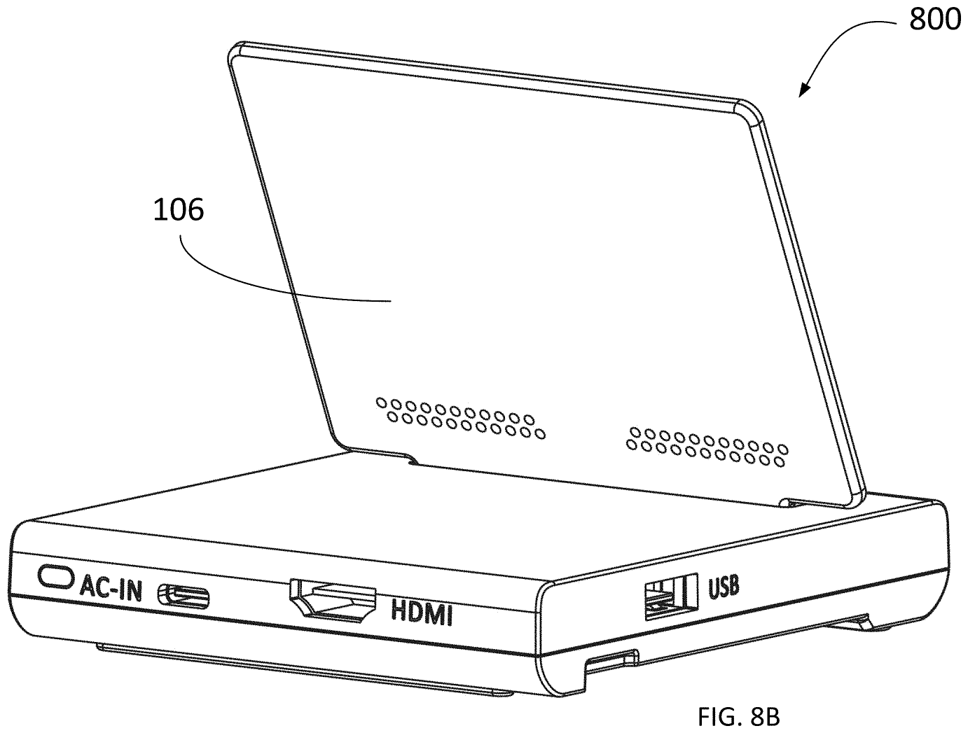

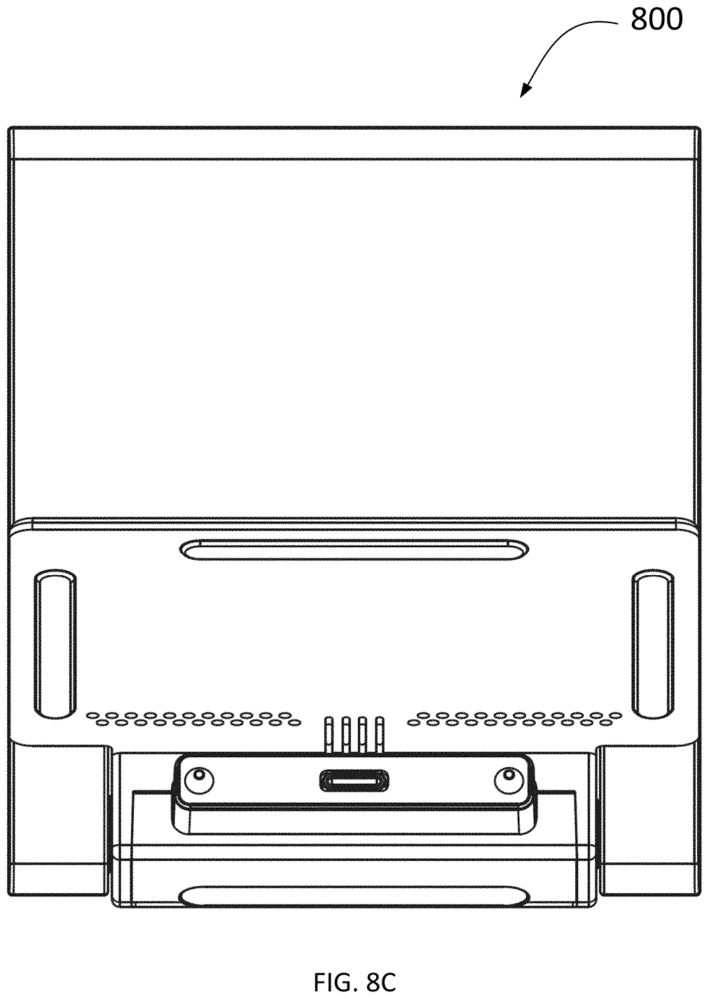

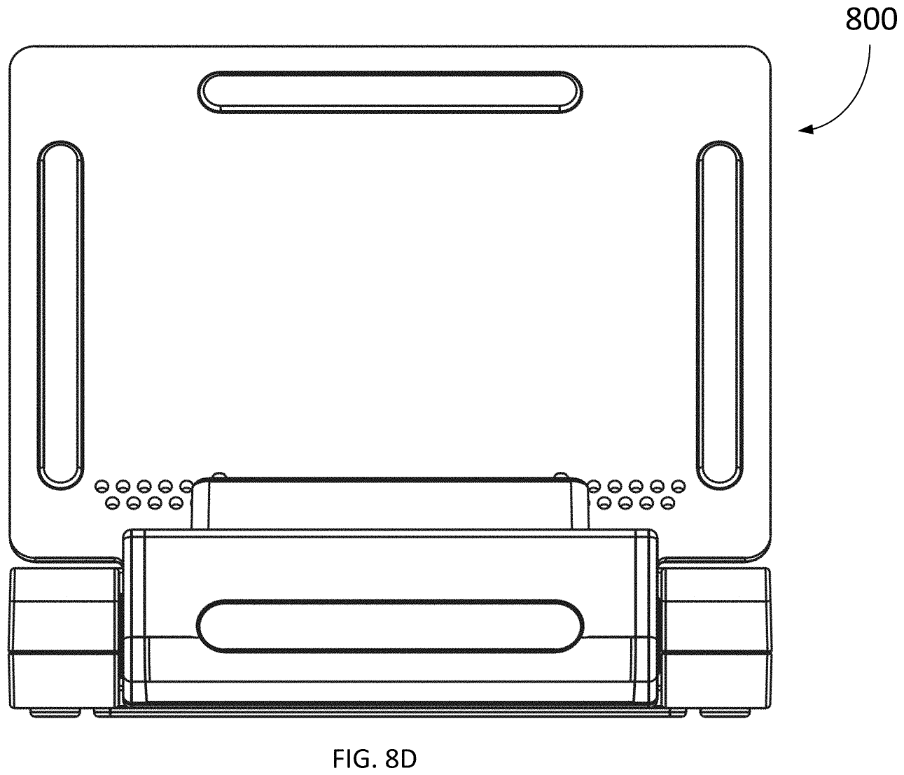

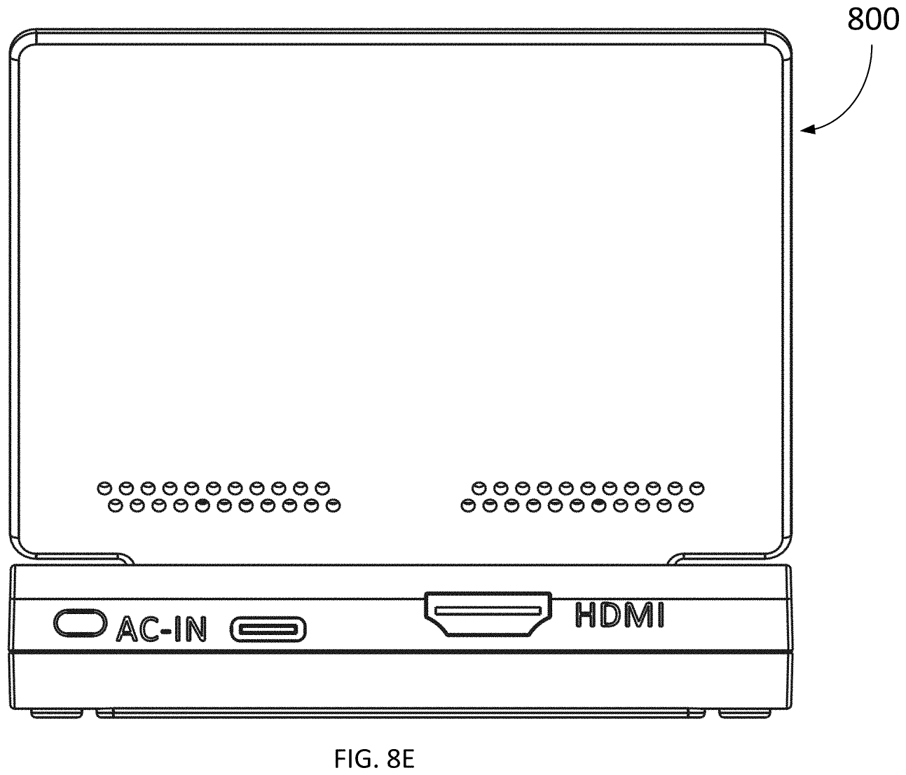

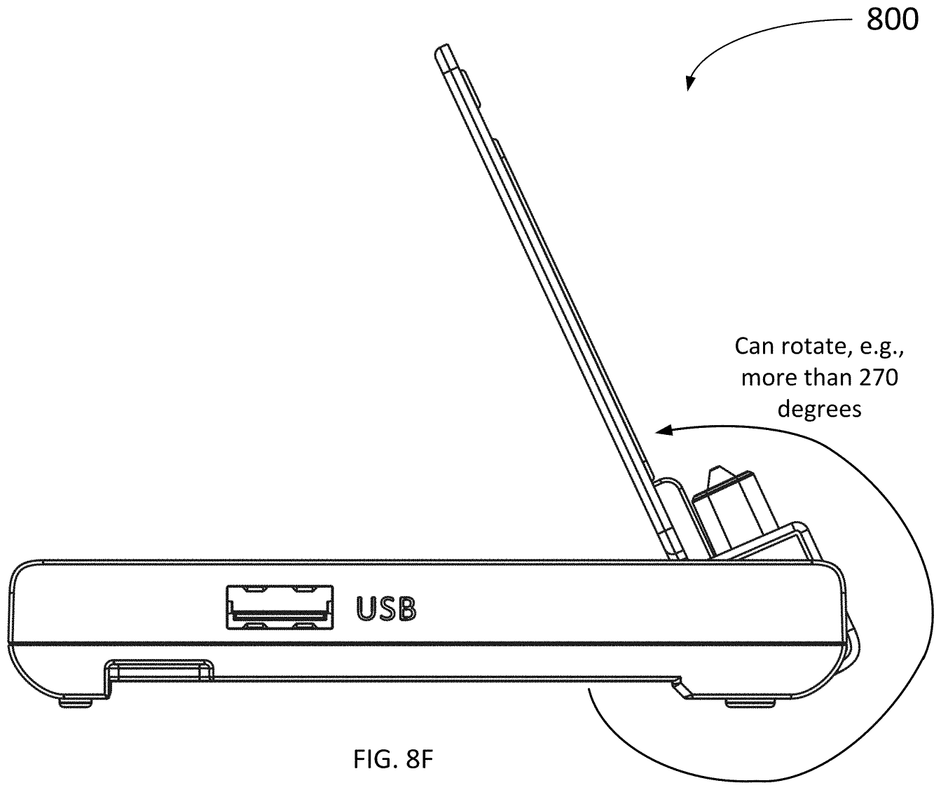

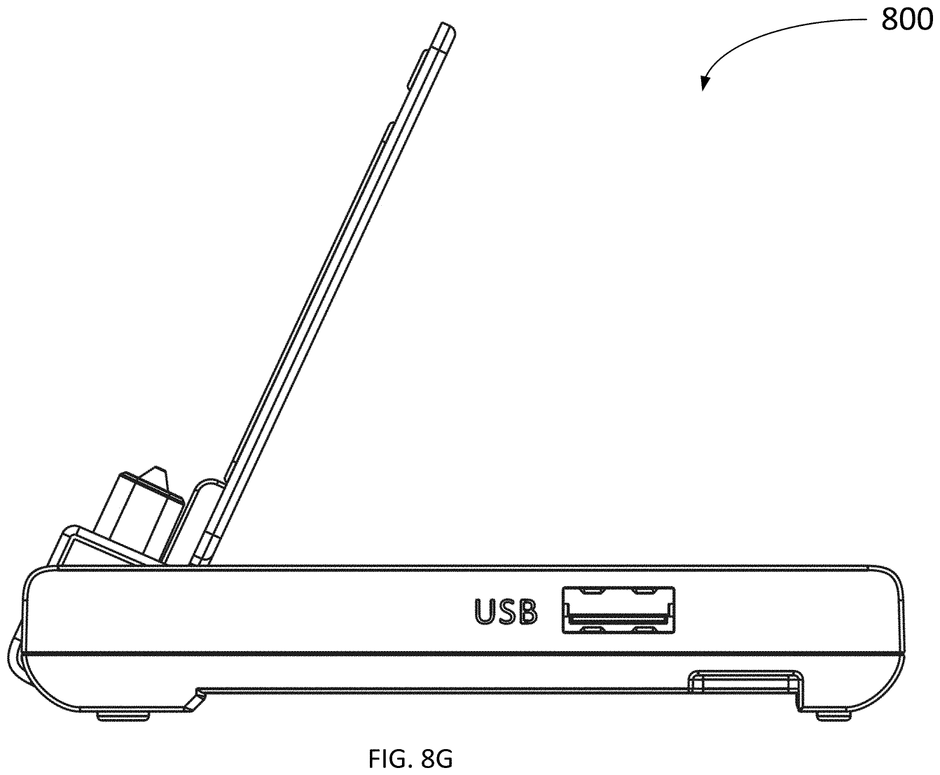

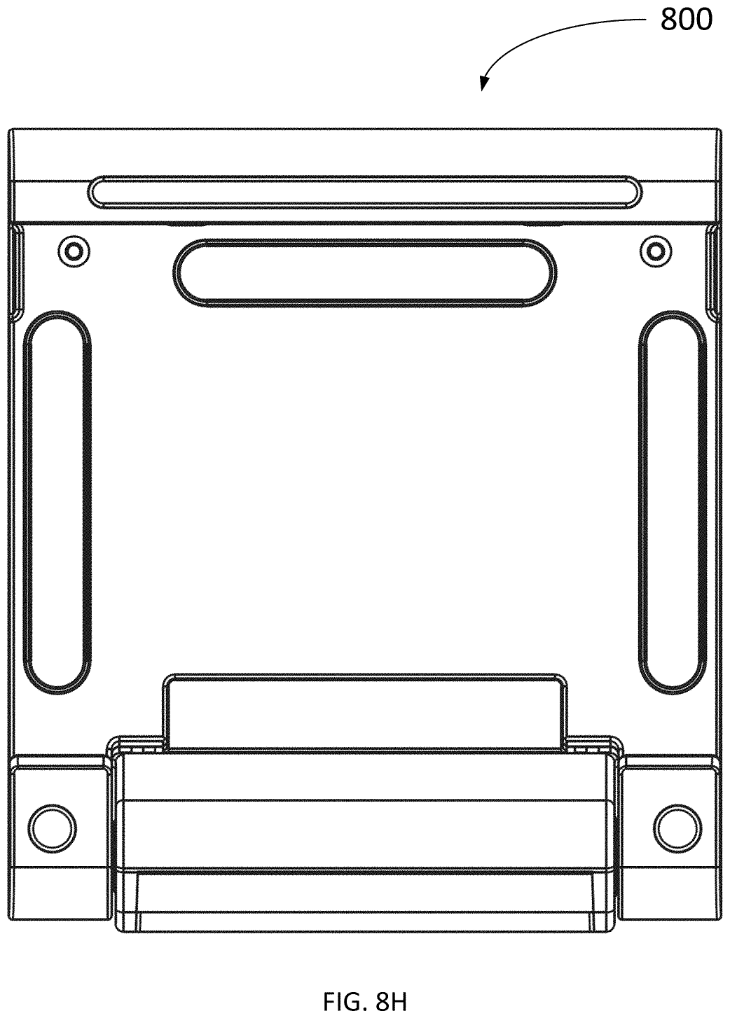

In some implementations, when the game console stand 100 is in use, the supporting member 1 is rotated from the closed configuration to the open configuration, and the rotation can be, e.g., more than 270° (see FIG. 8F). In the closed configuration, the supporting plate 102 has a first face 104 that faces the base 2 and a second face 106 that faces outwards and away from the base 2. In the open configuration, the first face 104 of the supporting plate 102 faces the back of the game console 700, and the second face 106 of the supporting plate 102 faces away from the game console 700.

In the process of rotating the connecting rod 111, the spring member 221 is compressed. When the spring member 221 rotates to a certain angle, the first contact face 1112 of the connecting rod 111 faces the spring member 221 so that the spring member 221 spreads flat again to secure the supporting member 1 at this position. At this moment, if the supporting member 1 rotates, the spring member 221 will be compressed again to generate the spring force. When the game console stand 100 is in use, if the supporting member 1 is pushed or rotated back by an external force, the spring member 221 will generate a certain level of spring force to limit the rotation of the supporting member 1. In this case, the rotation of the supporting member 1 can continue to rotate only if the spring force of spring member 221 is overcome. In the process of supporting and using the game console stand 100, the spring member 221 and the connecting unit 111 are configured to protect the game console stand 100 from damage by external forces and to prevent destabilization and other problems when in use. The overall design of the game console stand 100 is simple, practical, and structurally stable.

In some implementations, the supporting member 1 has a rotation angle of about 270° to 360° (from the closed position to the open position, or vice versa) when the game console stand 100 is in use. After the supporting member 1 is rotated and turned over (e.g., the face 104 of the supporting plate 102 facing the base 2 in the closed position now faces the user in the open position), the supporting member 1 reclines on the base 2, and the surface 106 of the supporting member 1 facing outward in the closed position now faces toward the rear and reclines on the base 2, allowing the base 2 to support and secure the position of the supporting member 1.

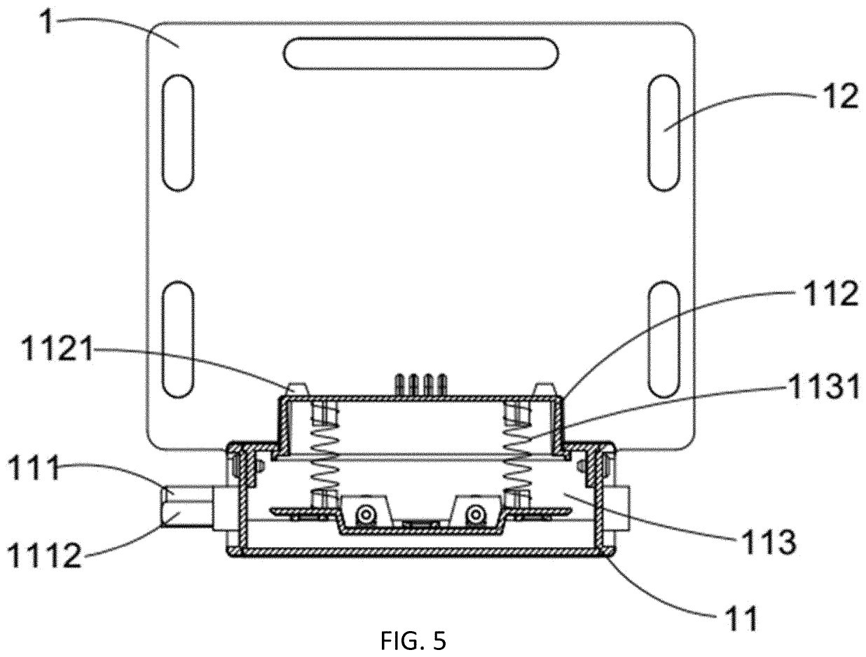

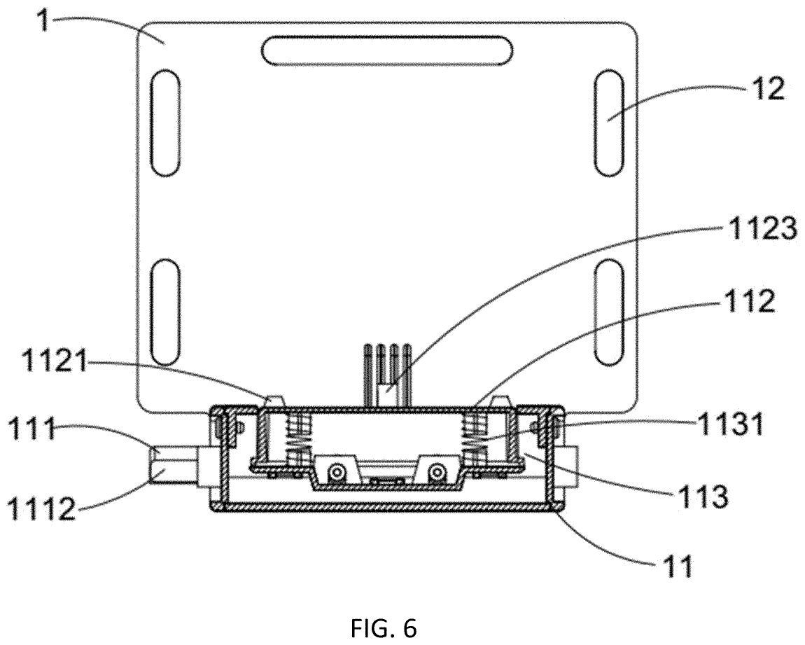

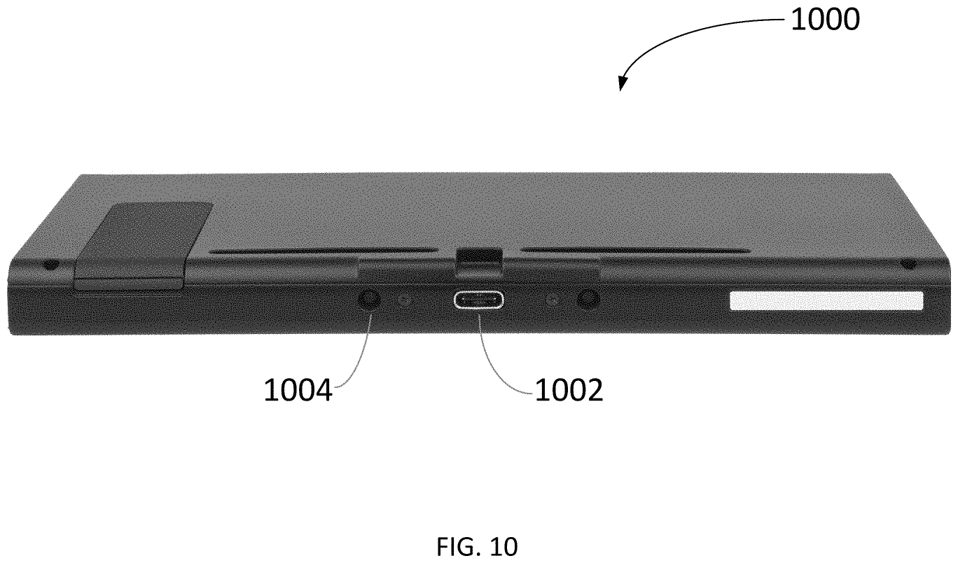

Referring to FIGS. 5 and 6, in some implementations, the connecting unit 11 includes a connector member 112 and a housing member 113, in which the connector member 112 can move relative to the housing member 113. The housing member 113 is received in the slot 21 (FIG. 2) of the base 2. When the game console 700 is not placed on the supporting member 1, the connector member 112 protrudes from the housing member 113. When the game console 700 is placed on the supporting member 1, the weight of the game console 700 causes the connector member 112 to be lowered into the housing member 113. The connector member 112 includes positioning pins 1121 that correspond to openings 1004 (FIG. 10) at the bottom of the game console 700. The positioning pins 1121 extend parallel to the supporting plate 102. When the game console 700 is placed on the supporting member 1, the positioning pins 1121 are inserted into the openings 1004 at the bottom of the game console 700 to secure the position of the game console 700 and prevent the game console 700 from sliding and falling off the supporting member 1.

A connector 1123 is provided in the housing member 113. The connector 1123 faces upwards. When the game console 700 is not placed on the supporting member 1, the connector 1123 is partially enclosed by the connector member 112. In the example shown in FIG. 1, the connector 1123 recedes into the connector member 112 such that the connector 1123 does not protrude beyond the top surface of the connector member 112. The connector member 112 prevents the connector 1123 from being damaged when the game console stand 100 is not in use and in the closed configuration. When the game console 700 is placed on the supporting member 1, the game console 700 pushes down on the connector member 112 to cause the connector member 112 to be lowered into the housing member 113. This causes the connector 1123 to be exposed and protrude from the connector member 112, allowing the connector 1123 to be coupled with the interface at the bottom of the game console 700. For example, the connector 1123 can be a male USB connector that couples with a female USB connector 1002 (FIG. 10) at the bottom of the game console 700. The connector 1123 faces towards the direction of the interface of the game console 700.

As shown in FIGS. 5 and 6, in some implementations, the connector member 112 can be received in the housing member 113. One or more springs 1131 are provided in the housing member 113, and the connector member 112 is coupled to the springs 1131.

A first jack 1122 (or opening) is positioned at the connector member 112, and the first jack 1122 and the positioning pin 1121 are placed in approximately the same plane. The USB port 1123 is placed in the connector member 112 and aligned with the first jack 1122. When the game console stand 100 is in use, the openings 1004 at the bottom of the game console 700 are coupled to the positioning pins 1121 so that the position of the game console 700 is secured. The connector member 112 is pressed into the housing member 113 when the game console is in use, so that the spring 1131 is compressed and the USB port 1123 protrudes from the connector member 112 and is inserted into the interface port of the game console 700. For example, this allows the battery of the game console 700 to be charged. After the user finished using the game console 700, the game console 700 is removed from the game console stand 100. The spring 1131 decompresses and pushes the connector member 112 out of the housing member 113, and the USB port 1123 is received inside the connector member 112.

In some examples, the game console 700 can consume a significant amount of power. In a conventional game console stand, the game console is directly connected to the external power line. The power line and the signal line may appear messy and unappealing, forming obstacles to the operation of the game console and causing inconvenience for the user. By comparison, the game console stand 100 described in this document sets the USB port 1123 inside the connector member 112, and the game console 700 is placed on the connector member 112 and coupled to the positioning pins 1121. The weight of the game console 700 pushes the connector member 112 into the housing member 113 so that the USB port 1123 protrudes from the housing member 113. The weight of the game console 700 pushes the USB port 1123 to be inserted into the game console 700 to enable the battery of the game console 700 to be charged. The positioning pins 1121 prevent the destabilization of the game console 700. When the game console 700 is in use, the connector member 112 is pressed into the housing member 113 and the spring 1131 in the housing member 113 is compressed to generate a spring force. After the user finished using the game console 700, the game console 700 is taken off the game console stand 100, and the spring 1131 decompresses and stretches to push the connector member 112 out to its original position, and the USB port 1123 is received inside the connector member 112. This design can protect the USB port 1123 from damage when the game console stand 100 is not in use and in the closed configuration, and the spring 1131 is set to automatically adjust the position of the connector member 112. The game console stand 100 can be operated easily and efficiently, and has a simple and appealing overall design, making the operation of the game console 700 more convenient to the user. In addition to the charging function, the USB port 1123 in the first jack 1122 can be used to connect with the game console 700 and other devices to transmit data or other signals.

In some implementations, the base 2 includes an upper cover plate 23 and a lower cover plate 24, in which the upper cover plate 23 and the lower cover plate 24 are fastened together by using, e.g., glue or screws, or by using a clasp or buckle mechanism. An inner chamber 25 is formed between the upper cover plate 23 and the lower cover plate 24, in which the chamber 25 is used to install one or more interior circuit boards or other circuit components. One or more second jacks 26 is/are placed at one or more sides of the base 2, in which the second jack 26 is used for, e.g., connecting with an external power source and/or other devices. The base 2 includes the chamber 25 for installing the circuit board. The multiple jacks 26 allow the functions of the base 2 to be expanded by connecting to different external devices that provide different functions. For example, the base 2 can be connected with an external power line for charging the battery of the game console 700, or connected with external audio devices, or connected with external display devices to project the game images, etc., and several devices can be connected to the base 2 simultaneously for providing multiple functions. The game console stand 100 is designed such that the circuit is placed inside the base place 2 to avoid messy lines and enhance the convenience to the user.

In some implementations, a secure or fixed part 241 is placed on the concave lower cover plate 24, in which when the game console stand 100 is not in use and in the closed configuration, the supporting plate 102 is coupled to the fixed part 241 to be secured. When the game console stand 100 is in use, the supporting plate 102 reclines on the upper cover plate 23. When the game console stand 100 is not in use and in the closed configuration, the supporting member 1 is coupled to the fixed part 241 of the concave part of base 2 to be secured. When in the closed configuration, the game console stand 100 has a flat structure and the supporting plate 1 does not protrude from the surface of the base 2, this makes the device more appealing. In addition, the design of the internally embedded supporting member 1 can protect the internal structures, such as the USB port 1123, more effectively.

In some implementations, one or more non-slip pads 12 are placed on the upper surface of the supporting plate 1. The non-slip pads 12 have a thickness and protrude slightly from the surface of the supporting plate 1. The fixed part 241 of the lower cover plate 24 includes one or more recessed or indented portions 2411 that correspond to and receive the non-slip pads 12. When the game console stand 100 is not in use and in the closed position, the non-slip pads 12 are received in the recessed portions 2411. The non-slip pads 12 are designed to stabilize and support the game console 700 when the game console 700 is placed on the game console stand 100. In some examples, the back side of the game console 700 has recessed portions, and the shapes of the non-slip pads 12 match the shapes of those recessed portions. This helps stabilize the console 700 on the stand 100 to prevent the console 700 from sliding.

FIGS. 8A to 8H are front perspective, rear perspective, top, front, rear, left, right, and bottom views, respectively, of an example game console stand (or dock or bracket) in an open configuration.

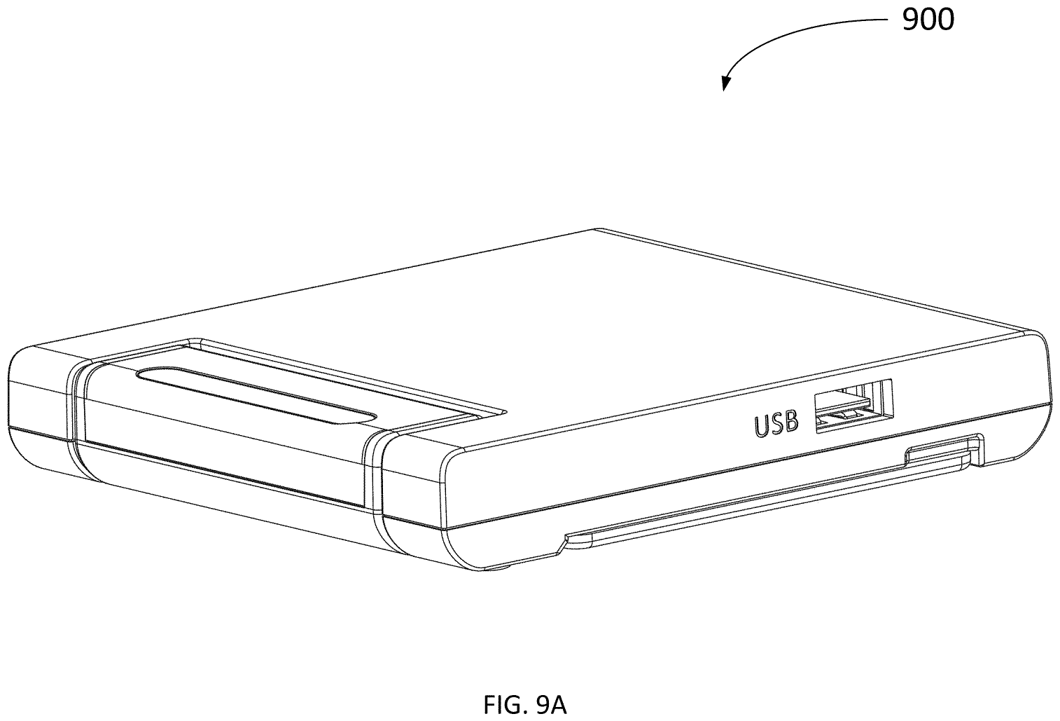

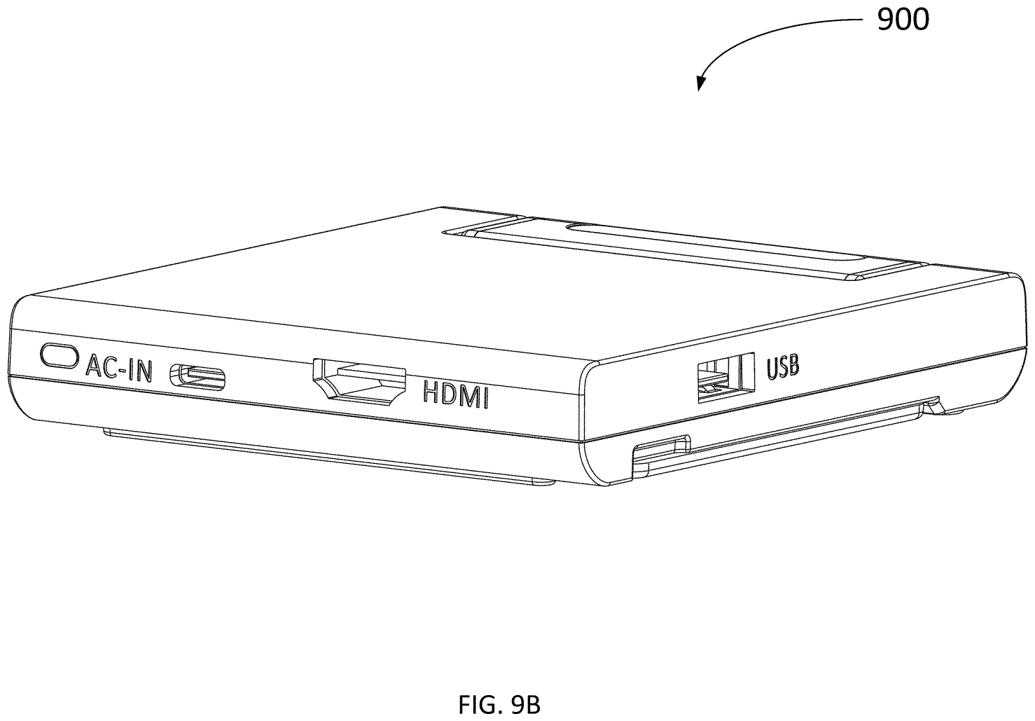

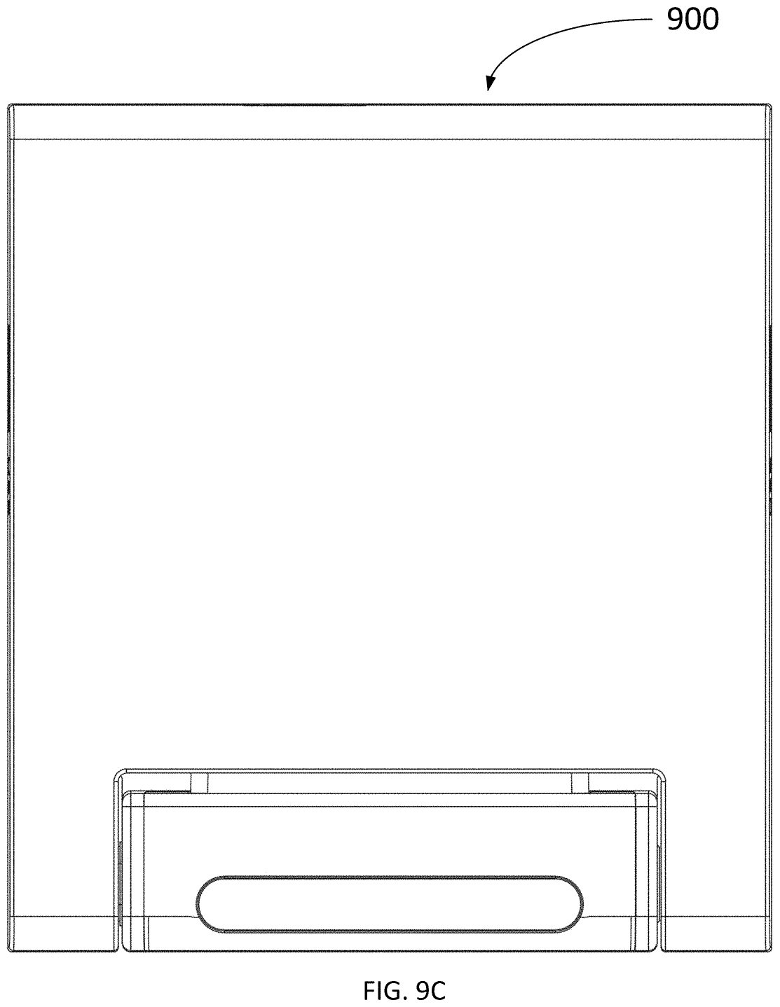

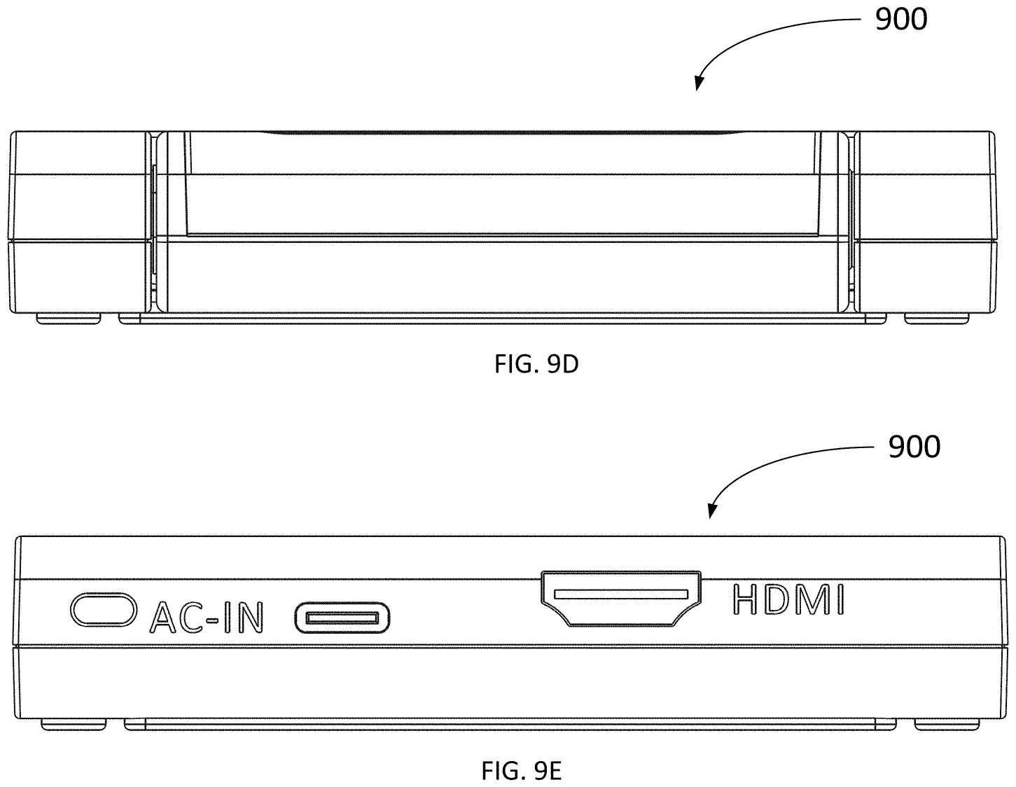

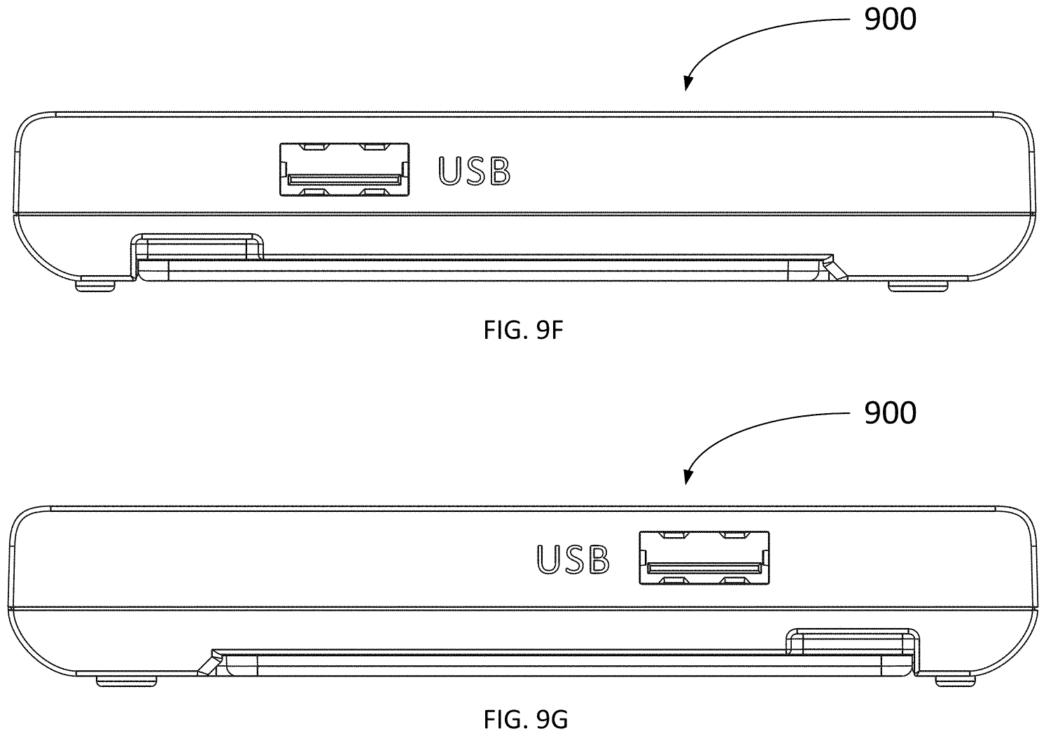

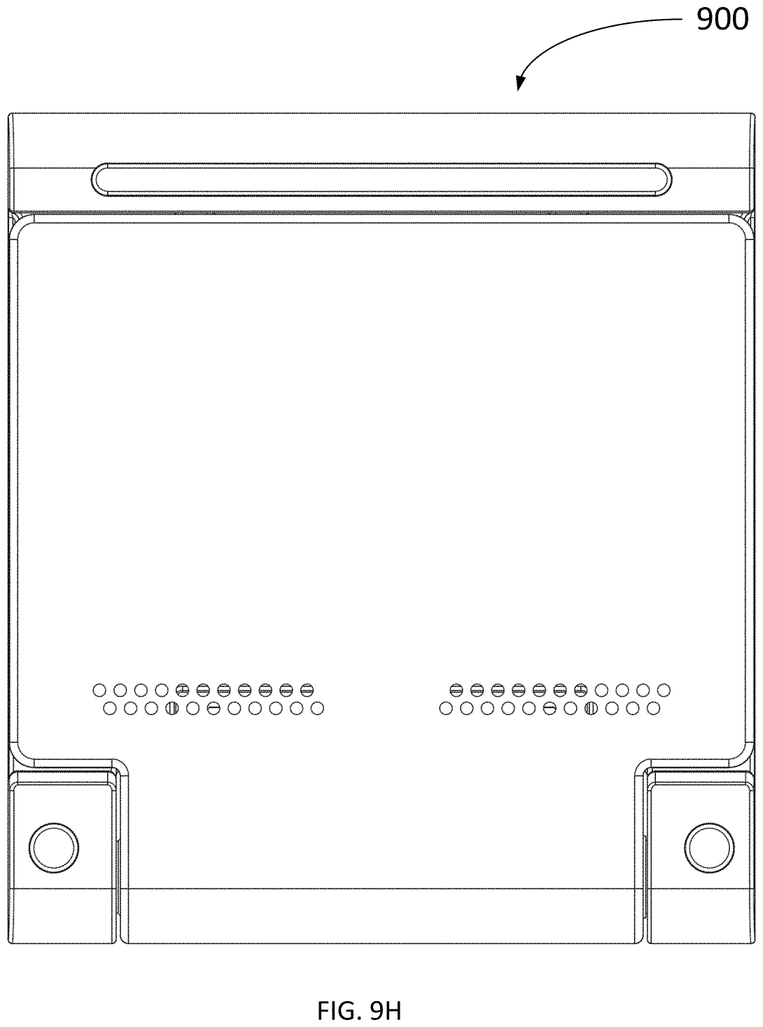

FIGS. 9A to 9H are front perspective, rear perspective, top, front, rear, left, right, and bottom views, respectively, of the example game console stand (or dock, or bracket) in a closed configuration.

FIG. 10 is a bottom view of an example gaming console that can be supported on the game console stand.

Particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. Although some examples have been discussed above, other implementations and applications are also within the scope of the following claims. For example, the connector 1123 can be other types of connectors, such as USB A-type, USB B-type, USB C-type, micro-USB A, micro-USB B, USB mini-b, USB 3.0 A-type, USB 3.0 B-type, USB 3.0 micro B, Apple lightning connector, etc. The stand 100 can be used to support, e.g., a mobile phone or a tablet computer in a position to allow the user to conveniently view the display on the mobile phone or tablet computer.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

What is claimed is:

1. An apparatus comprising:
a game console stand comprising:
a base having a top surface and a bottom surface; and
a supporting member rotatably coupled to the base, in which the supporting member comprises a supporting plate and a connecting unit, the supporting plate has a front surface and a back surface, the supporting plate is configured to provide support for a game console, the connecting unit is rotatably coupled to the base, and the connecting unit is configured to connect with an interface of the game console,
wherein the game console stand is configured to have an open configuration and a closed configuration,
wherein when the game console stand is in the closed configuration, the front surface of the supporting plate faces the bottom surface of the base, and the top surface of the base and the back surface of the supporting plate form the outer surfaces of the game console stand in the closed configuration, and
wherein when the game console stand changes from the closed configuration to the open configuration, the supporting plate is rotated outwards such that the front surface of the supporting plate faces away from the base and is configured to provide support for the game console.

2. The apparatus of claim 1 in which the base comprises two connecting slots, the connecting unit comprises connecting rods that are received at the connecting slots to enable the connecting unit to rotate relative to the base.

3. The apparatus of claim 2 in which the base comprises at least a spring member positioned inside at least one of the connecting slots, the spring member is coupled to the connecting rod received at the connecting slot,
the connecting rod comprises a first contact face and a second contact face, the first contact face is set at a first angle, the second contact face is set at a second angle,
when the stand is in the closed configuration, the connecting rod is configured to be in a first position such that the first contact face contacts the spring member,
when the supporting member is rotated from the closed position to the open position, the connecting rod rotates along with the supporting member, the first contact face is configured to move away from the spring member, and the connecting rod is configured to compress the spring member until the connecting rod rotates to a second position such that the second contact face contacts the spring member.

4. The apparatus of claim 3 in which connecting rod and the spring member are configured such that a force is required to further rotate the connecting rod away from the second position, the spring member provides a bias force against the second contact face when the connecting rod rotates away from the second position.

5. The apparatus of claim 4 in which when the game console stand is in the open configuration, the connecting rod is at the second position.

6. The apparatus of claim 1 in which the supporting member is configured to rotate in a range from 270° to 360° from the closed configuration to the open configuration.

7. The apparatus of claim 1 in which when the game console stand is in the open configuration, the back surface of the supporting plate forms an angle with the top surface of the game console stand, and the angle is less than 90°.

8. The apparatus of claim 1 in which the base comprises circuitry that is configured to interact with the game console.

9. The apparatus of claim 1 in which the connecting unit comprises a male or female connector, the interface of the game console comprises a female or male connector, and the male or female connector of the connecting unit is configured to couple to the female or male connector of the interface of the game console.

10. The apparatus of claim 1 in which the bottom surface of the base comprises a recessed portion that is configured to receive the supporting plate when the game console stand is in the closed configuration.

11. The apparatus of claim 1 in which the connecting unit comprises positioning pins that are configured to couple with recesses or holes at a bottom side of the game console.

12. The apparatus of claim 1 in which the connecting unit comprises a connector member and a housing member, the connector member is configured to be movable relative to the housing member between a first position and a second position,
wherein when the connector member is in the first position, a connector configured to connect with the interface of the game console is concealed within the connector member,
wherein when the connector member is in the second position, the connector extends outside of the connector member.

13. The apparatus of claim 12 in which the connector member comprises positioning pins that are configured to align with recesses or holes at a bottom side of the game console.

14. The apparatus of claim 12 in which the housing member comprises at least one spring that is coupled to the connector member, the spring biases the connector member to be in the first position when the game console is not placed on the game console stand.

15. The apparatus of claim 1 in which the base comprises an upper cover plate and lower cover plate, the upper cover plate and lower cover plate are fastened together, an inner chamber is formed between the upper cover plate and the lower cover plate, and an electronic circuit is installed in the inner chamber.

16. The apparatus of claim 15 in which the lower cover plate comprises a secure component, when the stand is in the closed configuration, the supporting plate secured to the lower cover plate by the secure component.

17. The apparatus of claim 16 in which the secure component comprises at least one of a hook or latch.

18. The apparatus of claim 15 in which when the stand is in the open configuration, the supporting plate is configured to recline on the upper cover plate.

19. The apparatus of claim 15 in which the supporting plate comprises at least one non-slip pad, the lower cover plate comprises at least one recessed portion to receive the at least one non-slip pad when the stand is in the closed configuration.

20. The apparatus of claim 1 in which a jack is placed at a side of the base, the jack is configured for connecting to at least one of an external power source or another electronic device.

21. An apparatus comprising:
a game console stand comprising:
a base;
a supporting member rotatably coupled to the base, the supporting member configured to support a game console when the game console stand is used to support the game console; and
a connector that is received within a housing member of the supporting member when the game console is not placed on the supporting member, wherein the connector protrudes from the housing member when the game console is placed on the supporting member, and the connector is coupled to an interface of the game console.
